(19) United States
(12) Patent Application Publication
(10) Pub. No.: US 2012/0286521 A1
(43) Pub. Date: Nov. 15, 2012

(54) COMPACT, HIGH-EFFICIENCY INTEGRATED RESONANT POWER SYSTEMS

(75) Inventor: J. Rhett Mayor, Stockbridge, GA (US)

(73) Assignee: GEORGIA TECH RESEARCH CORPORATION, Atlanta, GA (US)

(21) Appl. No.: 13/511,927

(22) PCT Filed: Nov. 23, 2010
(86) PCT No.: PCT/US10/57896

§ 371 Date: May 24, 2012

Related U.S. Application Data
(60) Provisional application No. 61/263,888, filed on Nov. 24, 2009.

(51) Int. Cl. H02K 7/18; B23K 3/00; F02B 75/32

(52) U.S. Cl. 290/1 A; 123/197.4; 29/888.012

(57) ABSTRACT

A compact, high output free-piston engine is described. The engine can be configured in radial and other configurations to increase energy density. The engine can comprise one or more pairs of opposed pistons. One piston can be used to derive work via internal combustion or an external heat source. The opposing piston can be disposed in a cylinder of fixed or variable volume to act as an air spring. In the configuration, the two pistons can act as a spring-mass system with a natural, or resonant, frequency. The one or more pairs of pistons can be coupled to a driveshaft using a one-way clutch to convert the reciprocal translations of the two pistons into rotary movement. The engine can be coupled to an advanced, highly efficient electrical generator to provide for the efficient localized production of electricity.

### BACKGROUND OF THE INVENTION

1. Field of the Invention

The present invention relates generally to an apparatus, system, and method for generating power and specifically to an apparatus, system, and method for generating electrical power using a compact, motor driven, electrical generator.

2. Background of Related Art

Despite the recent economic downturn and global recession, demand for electricity worldwide continues to grow. This is due to, among other things, the increased use of electricity in manufacturing and the continued development of electrical grids in second and third world nations. Total worldwide electrical consumption of electricity was estimated to be approximately 145 TWh in 2007 and is expected to increase to 216.38 TWh by 2035.¹ Unfortunately, based in part on the types of fuels used (e.g., coal) and the relative inefficiency of the machines used to convert these fuels to electricity, this level of power production will cause an estimated increase of CO₂ emissions from power production alone of approximately 15 billion metric tons per year by the year 2035.² ¹International Energy Outlook 2010, U.S. Energy Information Administration, page 9, available at www.eia.gov/oiaf/ieo/index.html.²Id. at page 8.

Power is generally produced at large, central power plants and can be generated using a variety of methods. Many clean alternatives exist including, but not limited to, solar, wind, and hydroelectric. Electricity is also produced relatively cleanly using nuclear fission. This type of power production, however, presents the problem of handling and storing radioactive nuclear waste, a byproduct of power production, in a safe manner. This requires its storage and containment for approximately 1000 years.

Due to its relative abundance and low cost, much of the world's electrical power is generated by burning solid and liquid hydrocarbons. Coal burning plants, for example, burn coal to produce heat to turn water into steam to power a steam turbine. This indirect type of power generation presents several obstacles to efficiently converting the chemical energy in the coal into electrical energy. These losses include, among other things, thermal and mechanical losses caused by system cooling requirements, friction, and exhaust. As a result, even the most sophisticated coal burning power plants operate at approximately 37-44% thermal efficiency.³ Even more advanced Natural Gas Combine Cycle (NGCC) power plants only provide 50-54% thermal efficiency.⁴ ³Electric Generation Efficiency, Working Document of the NPC Global Oil & Gas Study (Jul. 18, 2007) p. 5.⁴GT World, Handbook 2006.

Conventionally, power plants have been large, stationary plants connected to the power grid over long distances. This introduces an additional inefficiency—transmission losses. Transmission losses include thermal losses caused by resistance in the transmission wires, connectors, and switches themselves. In addition, transmission losses occur due to electrical energy leaking out of the wires and ionizing the air around the wires. Transmission losses are calculated by subtracting the amount of electricity sold to end users from the total amount of energy generated and were approximately 6.5% in 2007.

What is needed, therefore, is a system for efficiently generating power that minimizes thermal and mechanical losses with advanced materials and processes. What is also needed is a system that can efficiently generate power, while being small enough to be located close to the end user to minimize transmission losses. It is to such a system and method that embodiments of the present invention are primarily directed.

### BRIEF SUMMARY OF THE INVENTION

Embodiments of the present invention relate to an apparatus, system, and method for generating power and specifically to an apparatus, system, and method for generating electrical power using a compact, motor driven, axial flux generator. The system can comprise one or more pairs of opposed pistons disposed in similarly opposed cylinders. In some embodiments, multiple pairs of pistons and cylinders can be disposed in, for example and not limitation, a radial or flat configuration.

Each pair of pistons can comprise a work piston and a spring piston. The work piston can convert heat or chemical energy into work. The spring piston can operate in a sealed chamber and can act as a spring to oppose the motion of the work piston. The pistons can be coupled using a connecting rod. The pistons can comprise a spring-mass system with a natural, or resonant, frequency.

The one or more pairs of cylinders can be coupled to a common driveshaft using a one-way clutch. In this configuration, the cylinders can drive the driveshaft on the power stroke, but can be decoupled from the driveshaft on the compression stroke. The introduction of mechanical decoupling of the load during the compression stroke can provides for the return of resonant energy in the spring-mass system to perform a portion of the compression work of the cycle. Since the resonant energy of the spring-mass system provides much of the work required in the compression stroke of the power cycle, this work does not need to be supplied from the heat addition (i.e., from an external heat source or combusting fuel) and results in dramatic increases in efficiency over existing, conventional internal combustion power cycles. Furthermore, the initial start-up energy requirements of the system can be reduced by up to two orders of magnitude over existing constrained piston systems. This decoupling can enable the spring-mass system to operate at the natural frequency. At this frequency, a minimal amount of heat input translates into relatively high amplitude oscillations.

The driveshaft can enable the oscillating motion of the piston pairs to be converted into rotation motion. This rotary motion can be used to perform a variety of useful work. In some embodiments, the end, or snout, of the driveshaft can act as a rotor in a high-efficiency generator to provide compact powerful electrical generation. In some embodiments, the power cylinder can be fitted with externally controlled valves to enable the power piston and power cylinder to alternate between two and four stroke operation.

The foregoing and other objects, features, aspects, and advantages of the present invention will become more apparent from the following detailed description of the present invention when taken in conjunction with the accompanying drawings.

### BRIEF DESCRIPTION OF THE DRAWINGS

FIG. 1 depicts a front view of a radial, free-piston engine, in accordance with some embodiments of the present invention.

FIG. 2a depicts the compression event for a power piston in the engine of FIG. 1, in accordance with some embodiments of the present invention.

FIG. 2b depicts the ignition event for the power piston of FIG. 2a, in accordance with some embodiments of the present invention.

FIG. 2c depicts the power event for the power piston of FIG. 2a, in accordance with some embodiments of the present invention.

FIG. 2d depicts the exhaust event for a power piston of FIG. 2a, in accordance with some embodiments of the present invention.

FIG. 2e depicts another compression event for the power piston in the engine of FIG. 1, in accordance with some embodiments of the present invention.

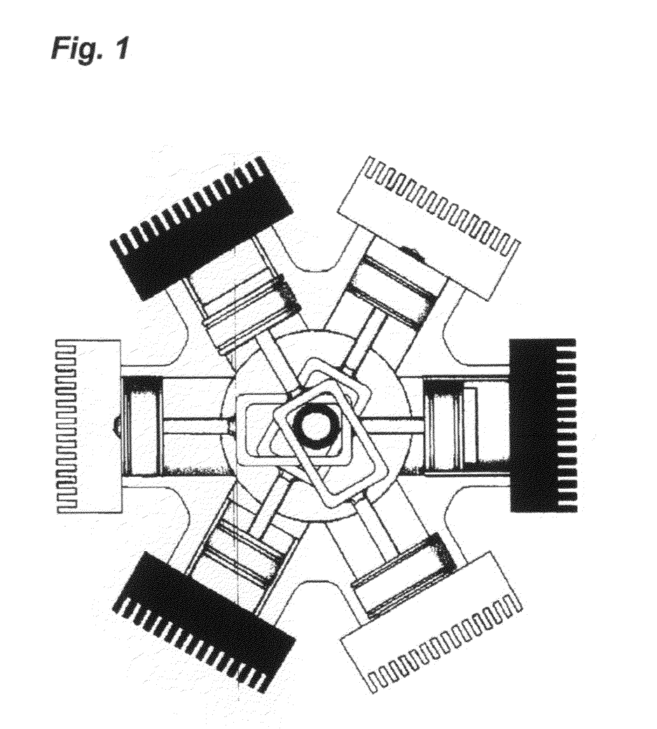

### DETAILED DESCRIPTION OF THE INVENTION

Embodiments of the present invention relate generally to an apparatus, system, and method for generating power, and particularly to an apparatus, system, and method for generating electrical power using a compact, motor driven, electrical generator (the “system”). The system can comprise, among other things, a resonant radial free piston (R2FP) engine driving an electrical generator (e.g., a radial-flux or axial-flux generator). The system is capable of high power density combined with low weight, low maintenance, and extended service life. The system enables a significant increase in efficiency along with mechanical simplicity.

To simplify and clarify explanation, the system is described below as a system comprising a two-stroke, hydrocarbon burning R2FP engine. One skilled in the art will recognize, however, that the invention is not so limited. The R2FP engine described is equally suited for use with compressed air, steam, or other energy source and need not necessarily facilitate internal combustion. The system can also be scaled to produce a range of power capacities for use at the power plant level down to individual use generators and vehicles.

The materials described hereinafter as making up the various elements of the present invention are intended to be illustrative and not restrictive. Many suitable materials that would perform the same or a similar function as the materials described herein are intended to be embraced within the scope of the invention. Such other materials not described herein can include, but are not limited to, materials that are developed after the time of the development of the invention.

As described above, a problem with conventional power production is low efficiency. In other words, very little of the chemical or mechanical energy input at the power station makes it to the end user in the form of electrical energy. This inefficiency is the result of a multitude of forces and inefficiencies including, but not limited to, frictional losses, pumping losses, reciprocating losses, transmission losses, and thermal losses. What is needed, therefore, is an apparatus, system, and method that can reliably and efficiently convert thermal or chemical energy into electricity by addressing as many of the aforementioned inefficiencies as is currently feasible.

The first of the inefficiencies addressed by embodiments of the present invention is reciprocating losses. As the name implies, reciprocating losses occur in engines in which there are reciprocating components. For example, with the exception of rotary engines, the standard internal combustion, i.e., two and four stroke engines found in nearly every vehicle in the world, consist of pistons connected to a rotating crankshaft via connecting rods.

In the case of the four stoke, as the pistons reciprocate through the power stroke, the connecting rods turn the crankshaft (or crank) converting the reciprocating energy of the pistons into rotational energy via the crank. In a four-stroke engine, however, this means that the piston has to stop and then be reaccelerated in the opposite direction four times per power pulse. As a result, pistons, connecting rods, and crankshafts are subjected to immense forces, especially at higher RPMs.⁵ This tremendous acceleration translates into massively strong (i.e., heavy) connecting rods and crankshafts to stop and reverse the piston's travel hundreds of times per second. The larger crankshaft and rods translate into larger bearing surfaces, greater heat generation, and higher vibration levels, among other things. ⁵In a modern Formula One engine, this can translate to piston acceleration at the top and bottom of the stroke of approximately 9,000 g's.

To address these reciprocating losses, embodiments of the present invention can employ an R2FP engine 100. The R2FP engine 100 can comprise one or more pairs of pistons, each pair comprising a work piston 105 and a spring piston 110. The work piston 105 can be configured, for example and not limitation, to operate on a two-stroke or four-stroke engine cycle. In a preferred embodiment, because a two-stroke engine provides a power pulse during every compression stroke, the work piston 105 can operate on a two-stroke cycle to increase energy density.

In some embodiments, the second, or spring piston 110 can be disposed opposite the work piston 105 in a spring cylinder 112. As the name implies, the spring piston 110 can act as a spring to counteract the force of the power stroke as the work piston 105 reaches the bottom of the stroke, or bottom-dead-center (BDC). In some embodiments, the spring piston 110 can be disposed in a sealed cylinder 112. As the work piston 105 descends, it compresses the air in the spring cylinder 112. When the force of the “spring” equals the force of the work piston 105, the work piston 105 stops (at BDC for the work piston 105).

BDC can be adjusted, therefore, by adjusting, among other things, the volume or the temperature in the spring cylinder 112. This can be done, for example and not limitation, by heating or cooling the spring cylinder 112. In some embodiments, a valve can be used to add or remove air from the spring cylinder 112 to adjust BDC. This specification can also be used to adjust the resonant frequency of the system 100.

In this configuration, therefore, the work piston 105 provides the work to the system 100 and the spring piston 110 acts as a spring, thus forming a spring-mass system 130. As with any spring-mass system 130, therefore, there is a frequency at which the system will resonate. This means that relatively small periodic inputs result in large oscillations of the spring-mass system 130. In conventional internal combustion engines, however, the pistons are connected directly to the crankshaft via connecting rods and must, therefore, prescribe a fixed displacement, or stroke. As such, and in conjunction with the absence of any spring in the piston-mass system, it is impossible for conventional internal combustion engines to establish useful vibratory resonant energy in the piston mass system. In addition, the crankshaft in conventional engines acts as a damper and precludes resonant vibration of the spring-mass system. In fact, because any resonant energy must be absorbed by the crank, resonance is generally avoided to prevent damage.

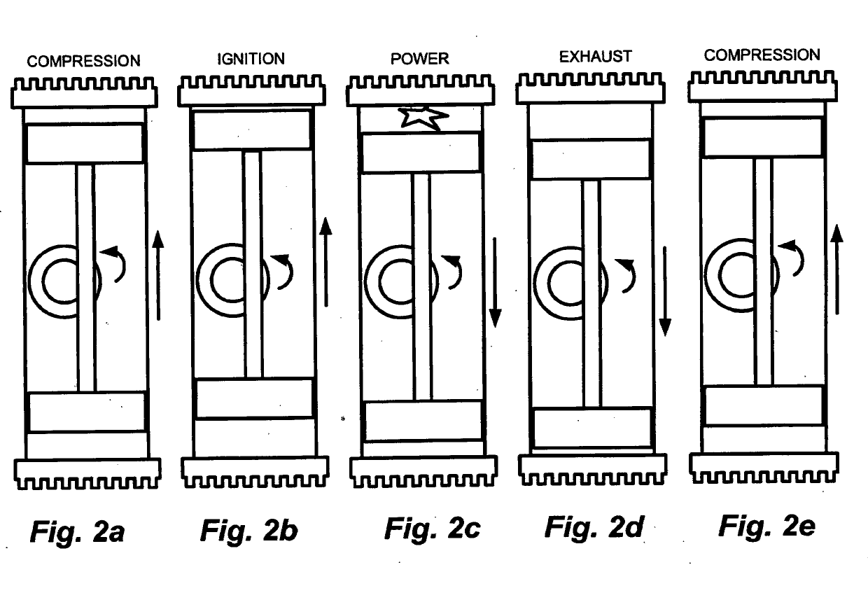

It is possible to take advantage of this resonant energy in a non-destructive manner, however, if the spring/mass system 130 can be decoupled from the driveshaft 115 at appropriate times. As shown in FIGS. 2a-2e, therefore, the pistons 105, 110 are not directly coupled to the driveshaft 115 as in a conventional reciprocating engine. Rather each pair of pistons 105, 110 is connected to one another using a connecting rod 120 and the connecting rod 120, in turn, is connected to the driveshaft 115 using a one-way coupler 125.

The one-way coupler 125 can be, for example and not limitation, a one-way clutch, magnetorheological clutch, electromechanical clutch, or a pawl and gear. The connecting rod 120 could, for example, comprise a rack type gear, while the driveshaft 115 is fitted with a pinion type gear. The pinion gear on the driveshaft 115, however, can be fitted with an electromechanical clutch. In this manner, the clutch can be engaged to enable the rack to drive the pinion on the power stroke, yet disengage on the compression stroke enabling the connecting rod 120 to decouple from the driveshaft 115. In other embodiments, the connecting rod 120 can be coupled to the driveshaft 115 using a magnetorheological coupling. The driveshaft 115 can, for example, be fitted with a series of vanes to form a rotor. The vanes can be surrounded by a toroidal housing connected to the connecting rod 120 and filled with a magnetorheological fluid (i.e., a fluid that increases its viscosity in response to an electrical current). The coupler 125 would be similar in design to a torque convertor on an automatic transmission. In this configuration, a small electrical current can be used to increase the viscosity of the fluid inside the coupler to effectively lock the connecting rod 120 to the driveshaft 115 on the power stroke. On the compression stroke, the current can be removed enabling the rotor to free wheel inside the housing, thus decoupling the connecting rod 120 from the driveshaft 115.

In still other embodiments, the coupler 125 can comprise a sprag clutch similar to those used in automotive automatic transmissions. The coupler 125 can also be a simple gear and pawl configuration similar to those used in a ratcheting hand tool. In other words, many types of one-way clutches can be utilized and are contemplated herein.

The one-way coupler 125 enables the connecting rod 120 to drive the driveshaft 115 during the power stroke for the work piston 105. During the compression stroke for the work piston 105, on the other hand, the one-way clutch 125 can enable the connecting rod 120 to decouple, or “free wheel,” with respect to the driveshaft 115. As depicted in FIGS. 2a-2e, therefore, any time the work piston 105 is traveling upwards, it is decoupled from the driveshaft 115. In this manner, the resonant energy inherent in the spring mass system130 can be harnessed and used to perform compression work in the power cycle.

FIGS. 2a-2e illustrate a complete power cycle for a single piston system 130. The driveshaft 115 can comprise a simple, circular throw coupled to a central shaft 117. The piston system 130, however, is not directly coupled to the driveshaft 115 using the connecting rod 120, but rather is connected to the driveshaft 115 via the decoupler 125. As shown, any time the work piston 105 is traveling upwards (i.e., on its compression stroke), it is decoupled from the driveshaft 115. In this manner, the spring piston 110 can do part of the compression work for the work piston 105 and the inherent resonance in the system 130 can be harnessed. This can enable the system 130 to reciprocate at high frequency, driving the driveshaft 115, with very little heat input to the work piston 105.

In FIGS. 2a-2e, the driveshaft 115 is being driven counter-clockwise. Of course, driveshaft rotation is arbitrary and could be clockwise if so required. In FIG. 2a, the work piston 105 is on the compression stroke. At this point, the spring effect from the air inside the spring cylinder 112 is driving the work piston 105 up in the work cylinder 107 and the work piston 105 is decoupled from the driveshaft 115. In FIG. 2b, the work piston 105 has reached top-dead-center (the top most part of its stroke, or TDC), while the spring piston 110 is at bottom-dead-center (the bottom-most part of its stroke, or BDC).

As mentioned, as the work piston 105 moves upward on the compression stroke, the piston decoupler 125 enables the work piston 105 to be decoupled from the driveshaft 115. At approximately TDC, fuel can be injected (if using direct injection) and ignition can be initiated, although one skilled in the art will recognize that injection and ignition timing can vary widely depending on, among other things, fuel quality, engine temperature, engine speed, and load. Ignition can be achieved, for example and not limitation, using a spark plug or by compression if the engine is a diesel.

FIG. 2c shows the power stroke for the work piston 105. As the fuel/air mixture burns, the gases inside the combustion chamber 109 expand rapidly driving the work piston 105 down. In this configuration, the power stroke for the work piston 105 achieves two things. The first is that the decoupler 125 locks the connecting rod 120 to the driveshaft 115 driving the driveshaft 115. The second is that the spring piston 110 is driven downward in the spring cylinder 112.

FIG. 2d shows the spring piston 110 reaching TDC, while the work piston 105 reaches BDC. As the work piston 105 passes BDC and begins to travel upward, the decoupler 125 again decouples the connecting rod 120 from the driveshaft 115. Because the spring cylinder 110 has reached TDC, its compressive force is at a maximum, causing the work piston 105 to stop and reverse its direction.

FIG. 2e shows the work piston 105 back on the compression stroke, driven by the spring energy from the spring piston 110 and the cycle repeats. The inputs to the system 100 can be varied to manage, among other things, power output, frequency (i.e., the RPM), emissions, and cooling. In some embodiments, for example, the pressure inside the spring cylinder 112 can be varied to increase power output. In other words, the higher the “spring-rate” in the spring cylinder 112, the more fuel and air can be introduced into the work cylinder 107. In some embodiments, the work cylinder 107 can be turbo or supercharged to increase the inlet pressure in the work cylinder 107. All else being equal, higher compression ratios translate into higher efficiency.

The sequence shown in FIGS. 2a-2e depicts a pair of reciprocating two-stroke pistons acting as a vibrating spring-mass system As a result, the engine speed can be regulated, using for example but not limitation, a conventional throttle plate, variable intake and exhaust ports, or fuel metering. The engine speed can be tuned to correlate to the resonant frequency of the system, which improves thermal efficiency by utilizing the vibrational energy inherent in such a system. In some embodiments, the engine can be a simple port or reed valve controlled two-stroke engine, as is known in the art.

In some embodiments, the power cylinder 107 can alternate between a two and four stroke cycle. This can be useful in providing an engine that can switch between high power output/higher emissions (two stroke) and high efficiency/lower emissions (four stroke). To enable this variable operation, the power cylinder 107 can comprise one or more intake valves and one or more exhaust valves that are externally actuated. These valves can be, for example and not limitation, electromagnetic, hydraulic, or pneumatic. The configuration can enable the valve train and the driveshaft to be independently controlled.

In a preferred embodiment, the valves and ignition timing of the engine can be computer controlled. When operating in two-stroke mode, therefore, the computer can open the intake and exhaust valve and fire the spark plug (unless a diesel) at appropriate times once per stroke of the power piston. When operating in four-stroke mode, on the other hand, the valves can be opened and closed to produce the traditional compression-ignition-exhaust-intake cycle of a four-stroke engine. In this manner, the power output and efficiency can be adjusted to meet power demand. In both modes, the valves can also be used to throttle the engine by varying the lift and/or duration of valve timing events, thus obviating the traditional throttle plate.

Efficiency can also be improved by reducing the mass of the spring mass system 130. The use of advanced design and materials can significantly reduce this reciprocating mass. Aluminum “slipper” pistons, for example, can be used. High-tech ceramics, such as silicon-nitride, can provide additional mass reductions with lower thermal expansion. Ceramics can enable tighter piston to cylinder wall clearances and higher operating temperatures, both of which improve engine efficiency.

The piston system 130 and the driveshaft 115 can also be designed to have a short “stroke.” In other words, if the distance between TDC and BDC for the piston system 130 is kept short, the size (i.e., radius) of the decoupler 125 and the driveshaft 115 can be small. This coupled with short pistons 105, 110 and connecting rods 120 can produce a reciprocating assembly 130 with minimal mass to enable the system 100 to operate at high frequency, or high driveshaft RPMs. This arrangement can provide high energy density (e.g., high horsepower) in a small package.

Heat engines (e.g., internal and external combustion engines) burn fuel to convert the chemical energy in the fuel to heat energy to mechanical energy. In a conventional reciprocating internal combustion engine, therefore, air is compressed by a piston, fuel is injected and ignited, and the burning mixture creates intense heat in the combustion chamber. This heat causes the previously compressed air to expand to several times is original volume driving the piston (which is connected to a crankshaft with a connecting rod) downward rotating the crank and creating rotational, mechanical energy. This rotational energy is easily applied, by gears, transmissions, or other means, to perform work (e.g., propel a vehicle).

Unfortunately, conventional materials are ill suited to convert this thermal energy into mechanical energy. Gasoline internal combustion engines generally convert only about 18-20% of the chemical energy in the fuel into useful work. The remaining 80% is wasted through the exhaust, cooling system, noise, friction, and other parasitic losses. This is partly due to the materials used in conventional engines.

Conventional engines are generally produced from alloys of aluminum, steel, and iron. These materials are relatively abundant, easy to manufacture, and durable. As metals, however, they are all very good conductors of heat and have relatively low melting points. Due to conduction of heat, therefore, the heat of the combustion process is not contained in the combustion chamber, but rather tends to heat the entire engine. As a result, modern engines are designed with complicated cooling and oiling systems designed to carry heat away to exterior radiators and oil coolers. These coolers are generally simple air-to-liquid heat exchangers that simply “dump” the heat into the atmosphere.

This cooling is also necessary to keep combustion chamber temperatures well below the melting point of the materials therein. Aluminum alloys are commonly used for piston, cylinder head, and cylinder block construction. The melting point of pure aluminum, however, is a mere 1220° F. Aluminum alloys and steel alloys can raise the melting temperature significantly, but melting point remains a limiting factor in heat engines.

TABLE 1
Comparison of Aluminum and Silicon-Nitride

| | Al | Si₃N₄ |
|---|---|---|
| Melting Point (° C.) | 660.32 | 1900 |
| Thermal Conductivity | 237 | 30 |
| (W/m° K) | | |
| Thermal Expansion | 23.1 | 3.4 |
| (μm/m° K) | | |

As a result, embodiments of the present invention can employ ceramic materials that have both significantly higher melting temperatures and significantly lower heat transfer rates. The pistons 105, 110, for example, can comprise silicon-nitride. As shown in Table 1, left, the melting point of silicon-nitride is nearly three times that of aluminum with less than 13% of the thermal conductivity. These means both that more combustion heat stays in the combustion chamber and that more combustion heat can stay in the combustion chamber. As a result, more work can be extracted from a given amount of fuel.

In some embodiments, ceramics can also be used for the cylinder liners and cylinder heads. The cylinder liners can comprise, for example and not limitation, cordierite or alumina. Cordierite, for example, can be manufactured to create a material with a very small coefficient of thermal expansion along one axis. This can be useful, for example, to maintain tight piston to cylinder head clearances, which can increase compression ratios.

The use of ceramic materials in and around the combustion chamber can both contain the heat of combustion and withstand the heat of combustion. As a result, little or no external cooling can be used reducing heat wasted by conventional cooling systems. The low coefficient of thermal expansion of these materials also enables tighter tolerances, which can increase compression and reduce blow-by (e.g., combustion gases blowing past the pistons into the crankcase) further improving efficiency.

Finally, the efficient generation of electricity requires an efficient means for converting the mechanical energy into electrical energy. Conventional free piston linear generators general comprise permanent magnets mounted on the connecting rod surrounded by stationary electrical coils through which the magnets oscillate. Unfortunately, as the magnets approach the edge of the winding, efficiency drops drastically due to so-called “edge effects.” One solution for this problem is for the windings to be long (i.e., wide enough to encompass the full motion of the connecting rod) increasing the size of the generator. Another solution is to make the magnets short, but this reduces output.

Converting the rotational energy of the driveshaft 115 into electrical energy is much more compact and efficient. In this configuration, the snout of the driveshaft 115 can act as the rotor for a generator/alternator. The driveshaft 115 snout can be, for example, fitted with rare earth magnets, such as for example and not limitation, neodymium magnets and samarium-cobalt magnets that produce a very strong electrical field. The permanent magnet rotor can then be surrounded by electrical windings, contained within a stator, to convert the rotational energy of the driveshaft 115 into electrical energy. In some embodiments, a cooling system can be provided for the magnets and/or the windings to prevent overheating and maintain efficiency. Advanced axial flux generators coupled with high rotor (i.e., driveshaft 115) speeds can provider improved power density and increased electromechanical efficiency.

As previously discussed, transmission losses waste approximately 6.5% of all power generated in the United States. Several factors, including but not limited to, economies of scale have resulted in a centralized electrical power system. Large central power generating stations are connected to end users via a network of wires and switches, or “the grid.” Transmission losses occur as electricity is consumed by, for example, heat, vibration, and noise, as it travels through the grid, sometimes for hundreds of miles.

Voltage and current are inversely related, such that very high transmission voltages enable the use of smaller wires than would otherwise be required. As a result, transmission losses are minimized over long distances by using very high transmission voltage. The large-scale transmission of electricity over long distances is accomplished using high voltage, or high-tension, wires suspended from large towers. The transmission portion of the grid is expensive to install and expensive to maintain. The height of the towers often necessitates the used of helicopters and other extreme measures to perform maintenance. In addition, the ground around high-tension lines is often cleared and maintained resulting in additional costs as well as soil erosion. Finally, the health effects of the relatively large electrical fields generated by electrical transmission are not fully understood.

The increased efficiency provided by embodiments of the present invention, however, can enable the decentralization of power production, obviating large, long distance, high-tension power lines and reducing or eliminate transmission losses. The two-stroke R2FP engine coupled with the advanced axial flux generator provides a compact, efficient, and power dense package. As a result, small efficient generators could be sized to provide power to, for example and not limitation, a single home, neighborhood, or community while minimizing or eliminating transmission losses. The system 100 can also provide cost-effective, reliable power to remote areas, including those currently dependent on less efficient and less reliable conventional generators.

As shown, if multiple pistons 105, 110 are desired, the engine can be configured in a radial configuration. In other embodiments, the pistons 105, 110 could be configured in a flat configuration (i.e., a “boxer” engine) and coupled to a common driveshaft. This can enable high power density in a compact package. For small applications, a single pair of opposed pistons 105, 110 can be employed. Of course, the displacement of the engine can be varied by changing the number of pairs of pistons 105, 110, the displacement of each pair, or both.

While several possible embodiments are disclosed above, embodiments of the present invention are not so limited. For instance, while several possible configurations have been disclosed (e.g., a two-stroke R2FP engine), other suitable materials and configurations could be selected without departing from the spirit of embodiments of the invention. In addition, the location and configuration used for various features of embodiments of the present invention can be varied according to a particular power requirements, space requirements, or cost constraints. Such changes are intended to be embraced within the scope of the invention.

The specific configurations, choice of materials, and the size and shape of various elements can be varied according to particular design specifications or constraints requiring a device, system, or method constructed according to the principles of the invention. For example, while certain exemplary ranges have been provided for thicknesses and locations, other configurations could be used for different sized bats or bats for different sports. Such changes are intended to be embraced within the scope of the invention. The presently disclosed embodiments, therefore, are considered in all respects to be illustrative and not restrictive. The scope of the invention is indicated by the appended claims, rather than the foregoing description, and all changes that come within the meaning and range of equivalents thereof are intended to be embraced therein.

What is claimed is:

1. A system for converting chemical or thermal energy into rotational work comprising:
a reciprocating unit comprising:
a power piston disposed inside a power cylinder;
a spring piston disposed inside a spring cylinder; and
a connecting rod pivotally coupled to the power piston and the spring piston;
a driveshaft for converting the reciprocating motion of the reciprocating unit into rotary motion; and
a one-way coupler pivotally coupling the reciprocating unit to the driveshaft;
wherein the one-way coupler couples the reciprocating unit to the driveshaft when the power piston is on a power stroke; and
wherein the one-way coupler decouples the reciprocating unit from the driveshaft when the power piston is not on the power stroke.

2. The system of claim 1, wherein the one-way coupler is a magnetorheological coupler.

3. The system of claim 1, wherein the one-way coupler comprises:
a rack disposed on the connecting rod; and
an electromechanical clutch for releasably coupling a pinion gear to the driveshaft.

4. The system of claim 1, wherein the one-way coupler comprises a sprag gear.

5. The system of claim 1, wherein the power piston and power cylinder are configured to operate on a two-stroke cycle.

6. The system of claim 1, wherein the power piston and power cylinder are configured to operate on a four-stroke cycle.

7. The system of claim 1, wherein at least the power piston and the power cylinder comprise ceramic materials.

8. A system for converting chemical or thermal energy into electricity comprising:
a plurality of reciprocating units, each reciprocating unit comprising:
a power piston disposed inside a power cylinder;
a spring piston disposed inside a spring cylinder; and
a connecting rod pivotally coupled to the power piston and the spring piston;
a driveshaft, comprising a first end and a second end, for converting the reciprocating motion of the plurality of reciprocating units into rotary motion;
a plurality of one-way couplers pivotally coupling each of the plurality of reciprocating units to the driveshaft; and
an electrical generator comprising:
a stator disposed around the first end of the driveshaft; and
a rotor comprising the first end of the driveshaft;
wherein each of the plurality of one-way couplers couples each respective reciprocating unit to the driveshaft when each respective power piston is on a power stroke; and
wherein each of the plurality of one-way couplers decouples each respective reciprocating unit from the driveshaft when each respective power piston is not on the power stroke.

9. The system of claim 8, wherein the plurality of reciprocating units are arranged in a radial configuration.

10. The system of claim 8, wherein the plurality of reciprocating units are arranged in a flat configuration.

11. The system of claim 8, wherein the first end of the driveshaft further comprises one or more magnets.

12. The system of claim 11, wherein the one or more magnets are rare earth magnets.

13. The system of claim 8, wherein the power piston is driven by an external heat source.

14. The system of claim 8, wherein the volume, temperature, or both of spring cylinder is adjustable.

15. A method of manufacturing a machine for converting chemical or thermal energy into rotational energy comprising:
inserting a power piston into a power cylinder;
inserting a spring piston into a spring cylinder;
coupling the power piston to the spring piston with a connecting rod; and
coupling the connecting rod to a driveshaft using a one-way coupler;
wherein the one-way coupler rigidly couples the connecting rod to the driveshaft when the power piston is on a power stroke; and
wherein the one-way coupler decouples the connecting rod from the driveshaft when the power piston is not on the power stroke.

16. The method of claim 15, wherein the power piston is driven by steam.

17. The method of claim 15, further comprising:
affixing one or more magnets to a first end of the driveshaft; and
disposing a plurality of electrical windings around the first end of the driveshaft to convert rotational energy from the driveshaft into electrical energy.

18. The method of claim 15, wherein the power piston and power cylinder are configured to operate as a direct-injection two stroke.

19. The method of claim 15, wherein the power piston and power cylinder are configured to operate alternately as a two-stroke and a four-stroke.
